(19) United States
(12) Patent Application Publication
(10) Pub. No.: US 2004/0194011 A1
(43) Pub. Date: Sep. 30, 2004

(54) Cooperative processing apparatus and cooperative processing method

(75) Inventor: Ryoji Matsumura, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/661,634

(22) Filed: Sep. 15, 2003

(30) Foreign Application Priority Data
Mar. 24, 2003 (JP) 2003-081613

(51) Int. Cl. G06F 17/21

(52) U.S. Cl. 715/500

(57) ABSTRACT

A cooperative processing apparatus judges that an error has occurred in an image processing apparatus if receiving a processing result indicating occurrence of an error from the image processing apparatus or receiving no processing result from the image processing apparatus in a prescribed time after requesting the image processing apparatus to execute a second service process. The cooperative processing apparatus generates new instruction data by removing execution-completed services from <exec> and attaching, as <log>, instruction data that was effective at the occurrence of the error.

### BACKGROUND OF THE INVENTION

1. Field of the Invention

The present invention relates to a cooperative processing apparatus and a cooperative processing method. In particular, the invention relates to a cooperative processing apparatus and a cooperative processing method for executing plural processing steps on an electronified document in a cooperative manner.

2. Description of the Related Art

A technique for increasing the processing speed of an on-line transaction process in a client-server system in which a server is provided with a database management system is known (e.g., JP-A-10-283319 (paragraphs 48-56)).

In the client-server system of the above patent document, as shown in its FIGS. 1 and 2, first an operator or the like inputs data to a slip, for example, through a slip input section 11 of a client 1 (step S1). If the operator or the like orders storage, the input data of the slip is supplied from the slip input section 11 to a data generation section 12.

On the basis of the received slip data, the data generation section 12 generates an electronic message to be used for sending the input transaction data collectively and sends the electronic message (step S2). The electronic message is transmitted to a server 2 via a network NW and received by a transaction storage section 21 of the server 2.

On the basis of the received electronic message, the transaction storage section 21 stores the transaction data of the slip in a slip transaction file 22 as a slip transaction table (step S3). Further, the transaction storage section 21 extracts, from the received electronic message, predetermined information for updating of another table and refers to definition information 23. Referring to the definition information 23 that is registered in a stored procedure table of a DBMS 24, the transaction storage section 21 supplies the DBMS 24 with a trigger that defines a manner of updating of another table using a stored procedure of the DBMS 24 on the basis of the received transaction data.

In response to the trigger, the DBMS 24 calls the stored procedure (step S4). It is checked whether an error has occurred in connection with the call of the stored procedure (step S5).

If no error has occurred, the DBMS 24 executes the called stored procedure and causes it to update a master table concerned in a master table file 25 (step S6). It is checked whether an error occurs during this updating operation (step S7). If no error has occurred, the process is finished.

If an error is detected at step S5 or S7, all the updating information is invalidated and rolling-back is performed on the stored information of the transaction data in the transaction storage section 21 (step S8), whereby the state before the occurrence of the latest transaction is recovered.

As described above, in the client-server system of the above patent document, all the updating information is invalidated and the original state is recovered if an error is detected.

Further, in conventional document processing systems that execute a document job flow, if a pre-designated, prescribed processing step (e.g., document processing, delivery, collection and delivery, transfer, conversion, storage, or the like) cannot be executed for a certain reason, the prescribed processing step is suspended or executed by a pre-designated substitute apparatus.

Therefore, those document processing systems have a problem that if a prescribed processing step is suspended, the flow is finished halfway. In addition, in those document processing systems, other conditions (e.g., a processing charge and a processing time) of a designated substitute system may not meet desired conditions of a user though the contents of a processing step are the same.

### SUMMARY OF THE INVENTION

The present invention has been made in view of the above circumstances, and provides a cooperative processing apparatus and a cooperative processing method that execute a cooperative process so as to satisfy desired conditions of a user after an error occurs during execution of a job flow.

The invention provides a cooperative processing apparatus including service execution requesting unit for requesting, on the basis of first cooperation instruction information that orders cooperative execution, via a network, of respective processes of plural services of a cooperative process on document data, a service processing apparatus for executing a service whose turn in order of the plural services has come to execute the service; and cooperation instruction information generating unit for generating, if a service whose turn has come has become unexecutable, second cooperation instruction information that orders cooperative execution of the service that has become unexecutable and services following it.

The invention also provides a cooperative processing method including a service execution requesting step of requesting, on the basis of first cooperation instruction information that orders cooperative execution, via a network, of respective processes of plural services of a cooperative process on document data, a service processing apparatus for executing a service whose turn in order of the plural services has come to execute the service; and a cooperation instruction information generating step of generating, if a service whose turn has come has become unexecutable, second cooperation instruction information that orders cooperative execution of the service that has become unexecutable and services following it.

### BRIEF DESCRIPTION OF THE DRAWINGS

Preferred embodiments of the present invention will be described in detail based on the following figures, wherein:

FIG. 1 is a block diagram showing the configuration of a document processing system according to an embodiment of the invention;

FIG. 2 is a block diagram showing mutual relationships between service processing apparatus constituting the document processing system;

FIG. 3 shows the structure of I/F information;

FIG. 4 shows an instruction data generation screen 100 that is a GUI screen to be used for defining a job flow;

FIG. 5 is a conceptual diagram of instruction data in XML format;

FIG. 6 is a block diagram showing the configuration of a cooperative processing server;

FIG. 7 is a flowchart of a process that is executed by a client terminal and an instruction data generation server in generating instruction data;

FIG. 8 is a flowchart of a process that is executed by the client terminal, the instruction data management server, and the cooperative processing server;

FIG. 9 shows an exemplary service cooperative process selection screen that represents an instruction data list;

FIG. 10 shows the structure of the main part of instruction data;

FIG. 11 shows the structure of the main part of instruction data after execution of a first service process;

FIG. 12 shows the structure of the main part of new instruction data that is generated when an error occurs during execution of a second service process;

FIG. 13 is a flowchart showing a process that is executed by the cooperative processing server when an error has occurred;

FIG. 14 shows the structure of the main part of instruction data with a substitutive condition;

FIG. 15 shows the structure of the main part of instruction data with a possibility of restart;

FIG. 16 shows the structure of the main part of instruction data with a substitutive condition and a possibility of restart;

FIG. 17 is a flowchart showing a cooperative process that is executed by the cooperative processing server; and

FIG. 18 is a table showing how the cooperative processing server selects a process for a combination of <substitutive condition> and <restartable> in instruction data.

### DESCRIPTION OF THE PREFERRED EMBODIMENTS

Preferred embodiments of the present invention will be hereinafter described in detail with reference to the drawings.

### Embodiment 1

[System Configuration]

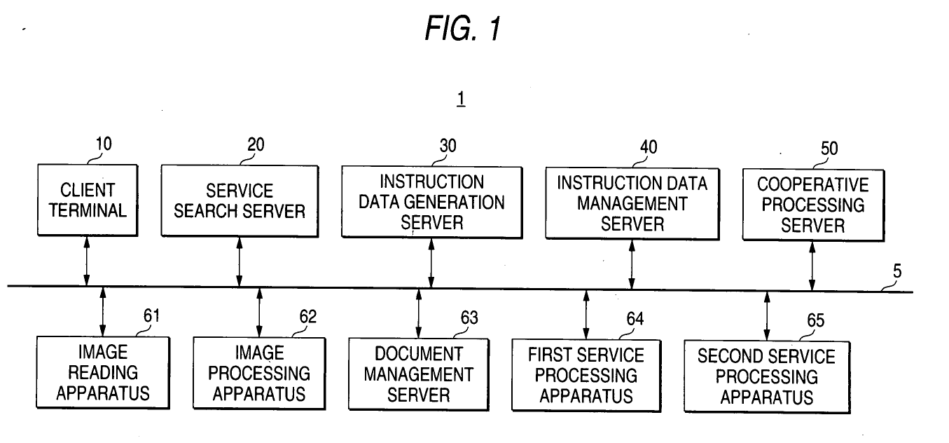

FIG. 1 is a block diagram showing the configuration of a document processing system 1 according to an embodiment of the invention.

The document processing system 1 is configured in such a manner that various services and applications are connected to each other via a network 5. The term “service” means a document-related function that can be used in response to an external request. The service may be of any kind and may be copying, printing, scanning, facsimile sending and reception, mail delivery, storage in a repository, reading from a repository, OCR (optical character recognition) processing, noise elimination processing, or the like.

Specifically, the document processing system 1 is equipped with a client terminal 10 having a user interface for ordering execution of a process desired by a user through cooperation between plural services, a service search server 20 for searching for a service desired by a user, an instruction data generation server 30 for generating instruction data on the basis of information relating to service cooperation that is specified by the client terminal 10, an instruction data management server 40 for managing instruction data, and a cooperative processing server 50 for executing a cooperative process of services according to instruction data.

The document processing system 1 is also equipped with an image reading apparatus 61 for generating an electronified image document by reading a paper document, an image processing apparatus 62 for performing image processing such as noise elimination processing, image rotation processing, and OCR processing on an image document, a document management server 63 for managing documents that have been subjected to image processing, a first service processing apparatus 64 for executing a first service process, and a second service processing apparatus 65 for executing a second service process.

Although the document processing system 1 according to this embodiment is configured in such a manner that the plural servers for executing respective prescribed service processes are connected to each other via the network 5, no particular limitations are imposed on the system configuration except that plural services should be connected to each other via a network 5.

The term “instruction data” means data including, when a process flow is decomposed into plural functional processing steps, information indicating relationships between the functions, interface (I/F) information to be used for calling each function, and information to be used for constituting a graphical user interface (GUI) relating to the process flow.

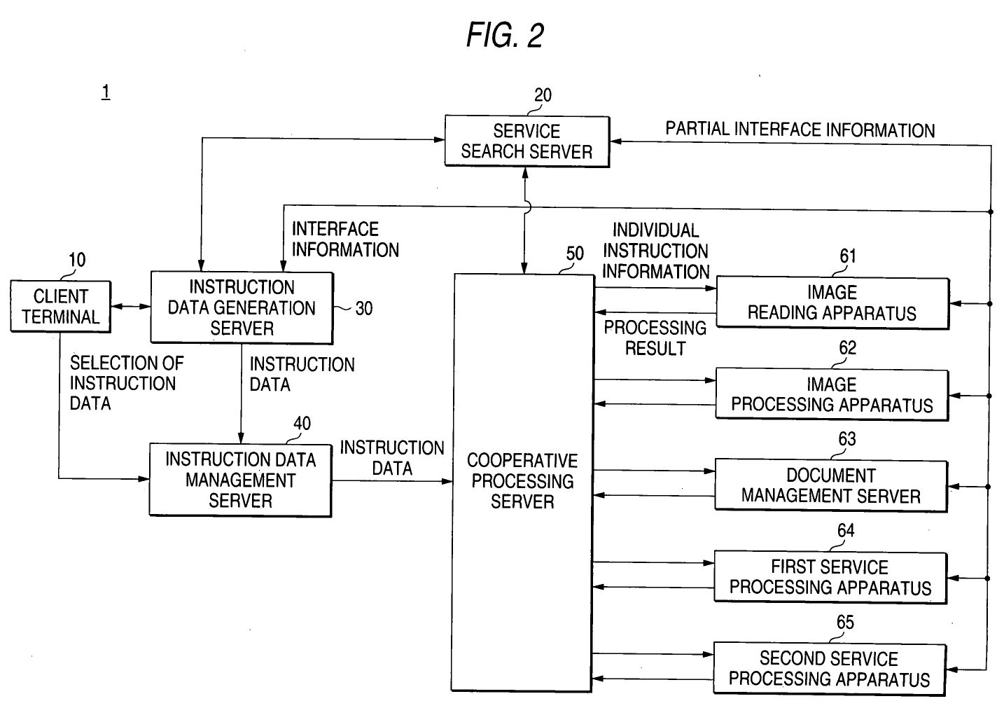

FIG. 2 is a block diagram showing mutual relationships between the service processing apparatus constituting the document processing system 1. Each service processing apparatus contains I/F information indicating the contents of a service provided by itself.

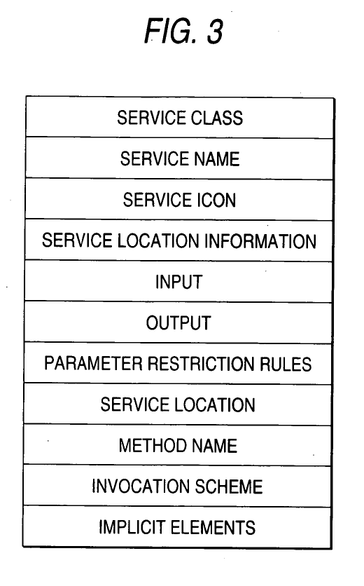

FIG. 3 is a conceptual diagram showing the structure of the I/F information. The I/F information is formed by <service class>, <service name>, <service icon>, <service location information>, <input>, <output>, <parameter restriction rules>, <service location>, <method name>, <invocation scheme>, and <implicit elements>. <Service class> is a class of a service provided by a service processing apparatus. <Service class> is a predefined service class and is scanning, printing, a repository, a flow, or the like. <Service name> is a name of the service provided by the service processing apparatus. <Service icon> is position information of an icon to be displayed on a GUI of the client terminal 10.

<Service location information> is a URL to be used for the instruction data generation server 30 to acquire I/F information. <Input> is an input to the service. <Output> is an output of the service. <Parameter restriction rules> is restriction rules that are applied to <input> and <output>. <Service location> is position information to be used when the service is performed actually. <Method name> is a name indicating a method for providing a service process or the service itself.

<Invocation scheme> is a method for calling and invoking a service process, and may be SOAP (simple object access protocol), SMTP (simple mail transfer protocol), or the like (SOAP and SMTP are message exchange protocols). <Implicit elements> is data that is not passed explicitly as an output to but can be referred to by a downstream processing step.

To make an instruction to generate instruction data or to select instruction data to be activated, the client terminal 10 has a graphical user interface (GUI) function for displaying a screen and allowing prescribed manipulations.

The service search server 20 searches the plural services connected to the network 5 for a service that satisfies search conditions. The service search server 20 contains, in advance, part of the I/F information (hereinafter referred to as “partial I/F information”) of each of the various service processing apparatus such as the image reading apparatus 61, the image processing apparatus 62, the document management server 63, the first service processing apparatus 64, and the second service processing apparatus 65. The term “partial I/F information” means, among the elements of the I/F information, <service class>, <service name>, <service location information>, <input information>, and <output information>.

When receiving search conditions from the instruction data generation server 30 or the cooperative processing server 50, the service search sever 20 searches for a service using the partial I/F information of each service processing apparatus. For example, to search for a service that is similar to a prescribed one, the service search sever 20 searches for a service in which coincidence is found in <service class>, a service in which coincidence is found in <input> and <output>, or a service in which coincidence is found in all of those elements.

The instruction data generation server 30 acquires the I/F information from each of service processing apparatus and generates instruction data for causing the service processing apparatus to cooperate with each other. More specifically, to generate instruction data, the instruction data generation server 30 executes the following process.

On the basis of <service location information>, the instruction data generation server 30 requests each of prescribed service processing apparatus distributed via the network 5 to send the I/F information of its service. If part of the prescribed service processing apparatus do not exist, the instruction data generation server 30 instructs the service search server 20 to search for other service processing apparatus capable of performing the same services as the part of the prescribed service processing apparatus are to perform. The instruction data generation server 30 may acquire <service location information> of other service processing apparatus from the service search server 20.

The instruction data generation server 30 manages search results received from the service search server 20 and the I/F information received from each service processing apparatus. On the basis of the I/F information acquired from each service processing apparatus, the instruction data generation server 30 generates an HTML file for a GUI screen to be used for defining a job flow. When receiving a service browsing request form the client terminal 10, the instruction data generation server 30 sends the HTML file for the GUI screen to the client terminal 10.

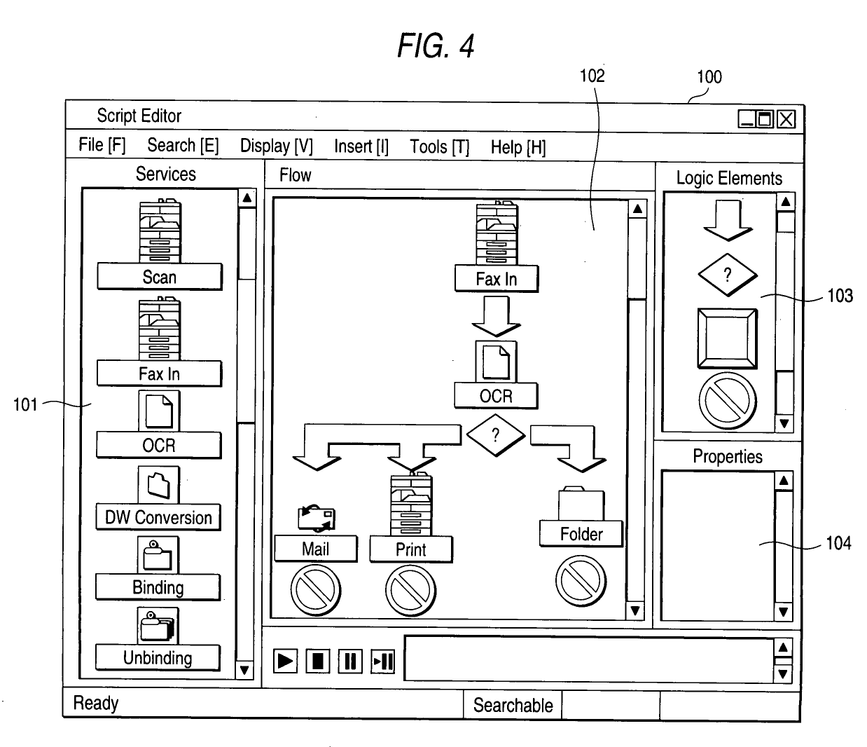

FIG. 4 shows an instruction data generation screen 100 that is a GUI screen to be used for defining a job flow. The instruction data generation screen 100 is formed by a service window 101, a flow window 102, a logic window 103, and a property window 104.

The service window 101 displays various usable service processing apparatus. The logic window 103 displays job flow elements to be used for indicating a pattern of cooperation between services. The property window 104 displays detailed setting parameters of each icon being displayed in the service window 101 and the logic window 103.

A user can define a job flow in the flow window 102 by drag-and-dropping icons in the service window 101 and icons in the logic window 103. Further, the user can set, in a detailed manner, relationships between services and logic elements by editing the displayed contents of the property window 104.

The client terminal 10 sends information of a job flow that has been defined by manipulations of a user to the instruction data generation server 30.

On the basis of job flow information relating to a user's instructions for service cooperation and the I/F information of each service, the instruction data generation server 30 generates instruction data that defines the contents of a process that each service processing apparatus will be requested to execute, input parameters, a manner of cooperation between services (i.e., a job flow), and information for identifying a document as a subject of processing such as a document name and storage location information. In this embodiment, instruction data is an XML file.

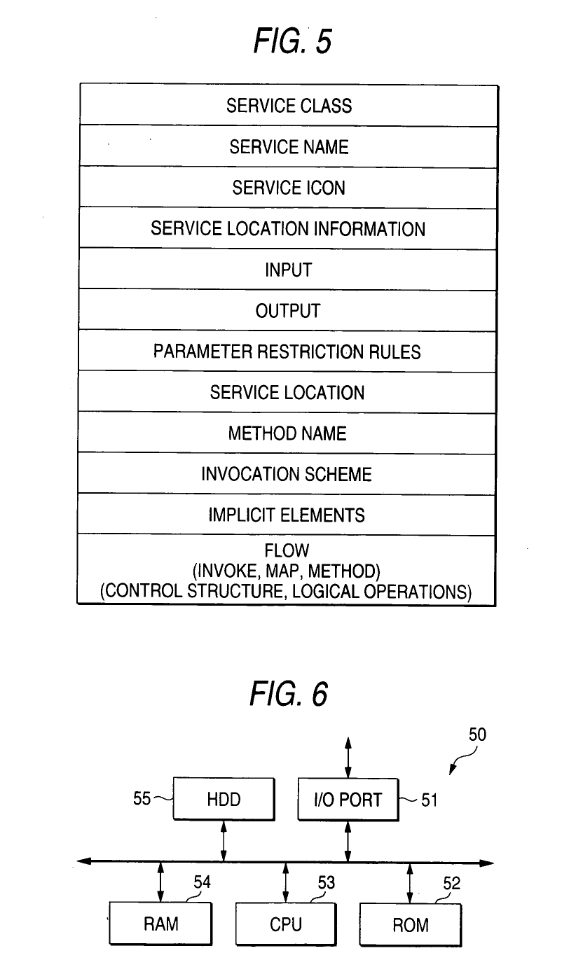

FIG. 5 is a conceptual diagram of instruction data in XML format. A cooperative process of plural services is also regarded as one service. Therefore, this instruction data is such that <flow> is added to the I/F information shown in FIG. 3.

<Flow> is an element that describes cooperation between services and includes <invoke>, elements such as <if> indicating a control structure, logical operations, and condition judgments, XML-structure manipulation instructions for adjustment of the cooperation between services, and information for identifying a document as a subject of processing.

<Invoke> indicates a particular method of a service processing apparatus and serves to call a service. <Invoke> has, as elements, <map> that indicates position information of parameters and <method> that is a method name for a call. <If>, <and>, <eq>, and <gt>, which indicate a control structure, logical operations, etc., serve to perform conditional branching during execution of a cooperative process and to adjust parameters that are exchanged between services.

In instruction data, all information relating to a control on a cooperative process of services is described in the elements of <flow>. Therefore, a cooperative process that is represented by instruction data is also regarded as one service. The structure of instruction data is not limited to the one shown in FIG. 5 and may be in any form as long as it enables cooperation between services.

The instruction data generation server 30 sends XML instruction data as described above to the instruction data management server 40. If execution of a service cooperative process has been ordered by a user, the instruction data generation server 30 may directly send instruction data to the cooperative processing server 50.

The instruction data management server 40 holds instruction data that have been sent from the instruction data generation server 30, and sends instruction data to the cooperative processing server 50 in response to a request from the client terminal 10.

The cooperative processing server 50 is a server for interpreting and executing designated instruction data. Upon receiving instruction data, the cooperative processing server 50 interprets it and executes a cooperative process by calling, in order, service processing apparatus such as the image reading apparatus 61, the image processing apparatus 62, and the document management server 63 according to order and methods of use that are described in the instruction data. The cooperative processing server 50 stores such information as a status of a cooperative process being executed and results of finished cooperative processes, and communicates a status or a result of a cooperative process in response to an external request.

In interpreting instruction data and requesting each service processing apparatus to perform its service, the cooperative processing server 50 generates individual instruction information including the contents of a processing request, input parameters, and information for identifying a document as a subject of processing. The cooperative processing server 50 may extract information indicating relationships between a service process to be executed by each service processing apparatus and service processes to be executed before and after the former in a cooperative process and describe those relationships in instruction data. Or the cooperative processing server 50 may request each service processing apparatus to execute its service process in an information exchange form that is specific to the latter rather than uses instruction data.

FIG. 6 is a block diagram showing the configuration of the cooperative processing server 50. The cooperative processing server 50 is equipped with an input/output port 51 for sending and receiving information to and from the network 5, a ROM 52 in which a cooperative process control program is stored, a CPU 53 for executing a cooperative process, a RAM 54 as a data work area, and a hard disk drive 55 for storing data that have been processed by the CPU 53 and other information.

For example, the input/output port 51 receives instruction data, sends individual instruction information to a service processing apparatus to request it to execute its service process, and receives a processing result from a service processing apparatus.

The CPU 53 controls the entire cooperative processing server 50. For example, the CPU 53 generates individual instruction information for each service processing apparatus on the basis of instruction data, and causes the instruction data to reflect a processing result of each service processing apparatus and requests the next service processing apparatus to execute its service process. If an error has occurred in a service processing apparatus, the CPU 53 generates new instruction data to execute the cooperative process again from the state of the instant when the error occurred. Further, the CPU 53 can control switching among re-execution (described above), suspension of a cooperative process, a search for a substitute service, and restart of a service flow from the start.

The image reading apparatus 61 generates an electronized image document by reading a paper document optically. The image reading apparatus 61 communicates partial I/F information to the service search server 20 at the time of starting and sends I/F information indicating a method for using its document management service to the instruction data generation server 30 in response to a request from it.

The image processing apparatus 62 is a computer in which a software program for an image processing function is installed. The image processing apparatus 62 processes a document on the basis of the contents of a service process request, input parameters, and information of a document as a subject of processing that are included in a process request sent from the cooperative process server 50. The image processing apparatus 62 communicates partial IF information to the service search server 20 at the time of starting. Further, the image processing apparatus 62 sends I/F information indicating a method for using its image processing service to the instruction data generation server 30 in response to a request from it. This I/F information is used in generating instruction data.

The document management server 63 has a document storage function. On the basis of information included in a request from the cooperative processing server 50, the document management server 63 stores, searches for, or reads a document, changes an attribute of a document, or performs one of other various kinds of processing. The document management server 63 communicates partial I/F information to the service search server 20 at the time of starting. Further, the document management server 63 sends I/F information indicating a method for using its document management service to the instruction data generation server 30 in response to a request from it.

The first service processing apparatus 64 is an apparatus for executing a prescribed service process relating to a document according to an external instruction. The first service processing apparatus 64 executes a service process that should be executed by itself on the basis of such information as the contents of a processing request from the cooperative processing server 50, input parameters, and information for identifying a document as a subject of processing. The first service processing apparatus 64 communicates partial I/F information to the service search server 20 at the time of starting. Further, the first service processing apparatus 64 sends I/F information indicating a method for using its service process to the instruction data generation server 30 in response to a request from it. The second service processing apparatus 65 operates in the same manner as the first service processing apparatus 64 does except for the contents of the service process.

In the document processing system 1 having the above configuration, the service processing apparatus such as the image reading apparatus 61, the image processing apparatus 62, and the document management server 63 operate as described below when application programs for execution of the respective prescribed service processes are installed therein.

In a starting process, each of the service processing apparatus such as the image reading apparatus 61, the image processing apparatus 62, and the document management server 63 communicates partial I/F information including its address and information indicating an outline of its service to the service search server 20.

The service search server 20 stores the pieces of partial I/F information that are sent from the service processing apparatus such as the image reading apparatus 61, the image processing apparatus 62, and the document management server 63. This allows the service search server 20 to do a search using the partial I/F information when receiving a prescribed service search request from the instruction data generation server 30 or the cooperative processing server 50, for example.

[Generation of Instruction Data]

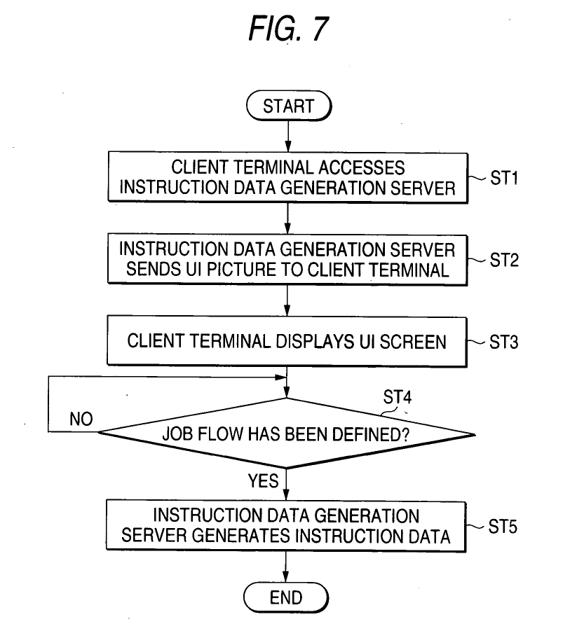

FIG. 7 is a flowchart of a process that is executed by the client terminal 10 and the instruction data generation server 30 in generating instruction data.

At step ST1, the client terminal 10 accesses, through a browser installed therein, according to a manipulation of a user, the instruction data generation server 30 at a URL (uniform resource locator) of an HTML file generated for a user interface screen to be provided by the instruction data generation server 30.

In response to a browsing request from the client terminal 10, at step ST2 the instruction data generation server 30 sends the HTML file of the user interface screen to the client terminal 10.

At step ST3, the client terminal 10 displays the user interface screen on the basis of screen forming information that is included in the HTML file sent from the instruction data generation server 30. A user can define a job flow of desired service cooperation using the user interface screen being displayed on the client terminal 10.

At step ST4, the client terminal 10 judges whether a job flow has been defined through the user interface screen. If not, the client terminal 10 waits until a job flow is defined. If judging that a job flow has been defined, the client terminal 10 sends, to the instruction data generation server 30, job flow information that relates to service cooperation that has been defined by the user.

At step ST5, the instruction data generation server 30 generates instruction data that defines the contents of a process that each service processing apparatus will be requested to execute, input parameters, a manner of cooperation between services, and information for identifying a document as a subject of processing such as a document name and storage location information on the basis of the information relating to the job flow of the service cooperation that has been sent from the client terminal 10 and I/F information acquired from each service processing apparatus. The instruction data generation server 30 sends XML instruction data to the instruction data management server 40.

The instruction data management server 40 stores the instruction data that has been generated by the instruction data generation server 30. Containing plural instruction data that were generated by the instruction data generation server 30, the instruction data management server 40 reads out selected instruction data when receiving an instruction data selection instruction from the client terminal 10.

[Activation and Execution of Cooperative Process]

A user can activate a cooperative process by selecting desired instruction data from the plural instruction data stored in the instruction data management server 40. The details will be described below.

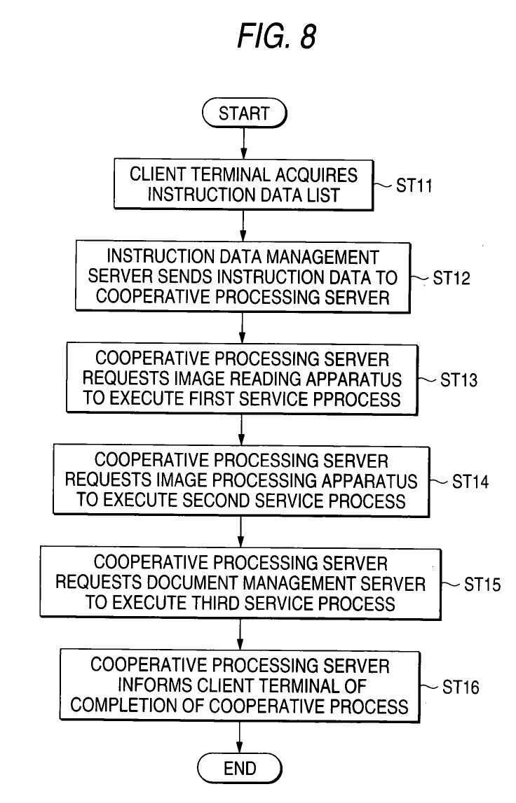

FIG. 8 is a flowchart of a process that is executed by the client terminal 10, the instruction data management server 40, and the cooperative processing server 50.

At step ST11, the client terminal 10 accesses the instruction data management server 40 and acquires an instruction data list that is managed by the instruction data management server 40.

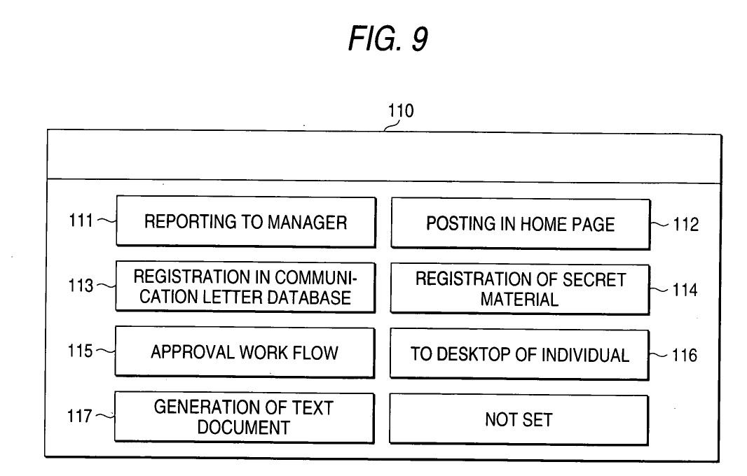

FIG. 9 shows an exemplary service cooperative process selection screen 110 that represents an instruction data list. The service cooperative process selection screen 110 has instruction data selection buttons 111-117 for respective instruction data. A user can select instruction data by clicking on a desired button in the service cooperative process selection screen 110.

The client terminal 10 selects instruction data corresponding to the text document generation button 117, for example, on the basis of a manipulation instruction of a user and activates that instruction data. The following description is directed to a case that the instruction data corresponding to the text document generation button 117 has been selected.

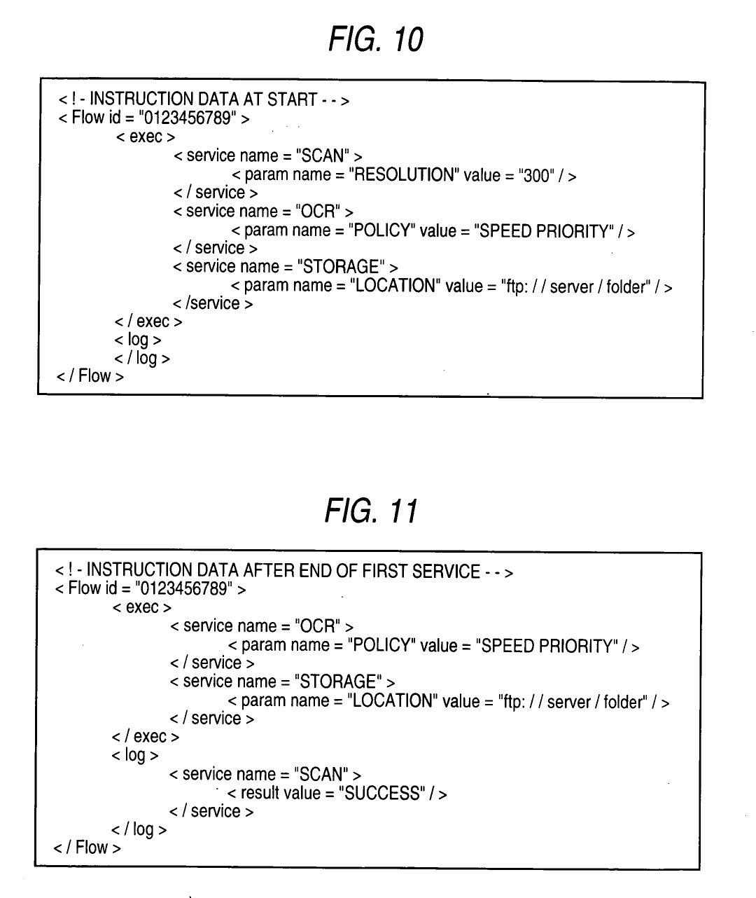

FIG. 10 shows the structure of the main part of the instruction data. This instruction data represents a process that includes (1) generating an image document by scanning a paper document (first service process), (2) generating a text document by performing OCR processing on the image document (second service process), and (3) storing the image document and the text document (third service process). FIG. 10 shows, in XML format, the <flow> portion of the instruction data shown in FIG. 5.

As shown in FIG. 10, to discriminate itself from other instruction data, the instruction data includes a unique ID <id=“0123456789”> in the tag of <flow>. Further, the instruction data has, as elements of <flow>, <exec> for showing the contents of the respective services before their execution and <log> for showing the contents of respective services after their execution.

<Exec> has <service> for each of the first to third services. The tag of each <service> has “name” that indicates a name of the service. Each <service> has <param> for setting the contents of the service.

The tag of <param> has “name” that indicates a name of the parameter and “value” that indicates a setting value of the parameter. “Value” takes various forms such as a numerical value, an operation mode, and a URL depending on the type of <param>, and is not limited to particular forms.

For example, the name of <service> relating to the first service process is “scan.” The name of <param> is “resolution” and the setting value is “300,” which means that image reading (i.e., scanning) is performed at a resolution 300 dpi. The name of <service> relating to the second service process is “OCR.” The name of <param> is “policy” and the setting value is “speed priority,” which means that OCR processing is performed with priority given to the speed. The name of <service> relating to the third service process is “storage”. The name of <param> is “location” and the setting value is “ftp://server/folder,” which means that a document is stored at “ftp://server/folder” (URL).

At step ST12, the instruction data management server 40 sends the cooperative processing server 50 the instruction data that has been selected by the client terminal 10. In response, the cooperative processing server 50 starts execution of the cooperative process.

At step ST13, the cooperative processing server 50 interprets the instruction data sent from the instruction data management server 40, and requests the image reading apparatus 61 corresponding to the first service process described in the instruction data to execute the first service process. More specifically, the cooperative processing server 50 extracts the information relating to the first service process from the instruction data and generates individual instruction information. The cooperative processing server 50 sends the individual instruction information to the image reading apparatus 61 which is the first service process request destination.

The image reading apparatus 61 generates an image document by scanning a paper document at a resolution 300 dpi on the basis of the individual instruction information sent from the cooperative processing server 50. Upon completion of this processing, the image reading apparatus 61 sends the cooperative processing server 50 processing results such as process status information (completion), output parameters, and processed document storage destination information.

Receiving the processing results from the image reading apparatus 61, the cooperative processing server 50 deletes the contents “scan” of the first service process that is described in the instruction data and describes, as a log, a result of the first service process.

FIG. 11 shows the structure of the main part of the instruction data after execution of the first service process. It is seen that the cooperative processing server 50 has deleted the information relating to <service> “scan” from the <exec> portion of the instruction data, described <service> “scan” in the <log> portion, and written a setting value “success” in <result> that indicates a processing result.

At step ST14, the cooperative processing server 50 identifies a second service process request destination on the basis of the instruction data and requests the image processing apparatus 62 to execute the second service process. More specifically, the cooperative processing server 50 extracts, from the instruction data, a location of a service processing apparatus that will be requested to execute the second service process, formats of input parameters and output parameters that are necessary to make such a request, a method name for making such a request, an invocation scheme, and information for identifying the document as the subject of processing, and generates individual instruction information. The cooperative processing server 50 sends the individual instruction information to the image processing apparatus 62 as the second service process request destination.

The image processing apparatus 62 produces an image document by copying the document as the subject of processing on the basis of storage destination location information of the document as the subject of processing that is described in the received instruction data. The image processing apparatus 62 interprets the contents of the service process request, performs image processing such as noise elimination and OCR processing on the produced image document, and binds a resulting image document and an extracted text document into one document. The image processing apparatus 62 re-stores, in the original storage destination, the document produced by binding the image document that has been subjected to the image processing and the text document. Upon completion of the above processing, the image processing apparatus 62 sends the cooperative processing server 50 processing results such as process status information (completion), output parameters, and processed document storage destination information.

Receiving the processing results from the image processing apparatus 62, the cooperative processing server 50 deletes the contents “OCR” of the second service process that is described in the instruction data and describes, as a log, a result of the second service process. At step ST15, the cooperative processing server 50 identifies a third service process request destination on the basis of the instruction data and requests the document management apparatus 63 to execute the third service process. As in the case that it sent the second service process request, the cooperative processing server 50 sends the document management server 63 individual instruction information (i.e., information relating to the processing request such as information to the effect that a certain document will be stored, information of a document storage destination, and information for identifying the document as the subject of processing).

On the basis of the contents of the request sent from the cooperative processing server 50, the document management server 63 stores the document that has been processed and stored by the preceding process (i.e., second service process) at the location that is described in the request. Upon completion of this processing, the document management server 63 sends the cooperative processing server 50 processing results such as process status information (completion), output parameters, and processed document storage destination information.

Receiving the processing results from the document management server 63, the cooperative processing server 50 deletes the contents “storage” of the third service process that is described in the instruction data and describes, as a log, a result of the third service process. If judging that no next service process is described in the instruction data, at step ST16 the cooperative processing server 50 sends the client server 10 a notice to the effect that all the processes have finished. The cooperative process is then finished.

[Measures Taken at the Occurrence of Error]

If an error occurs during execution of a cooperative process, the cooperative processing server 50 generates new instruction data. The following description is directed to a case that the image processing apparatus 62 does not perform OCR processing successfully at step ST14 in FIG. 8.

If receiving a processing result indicating occurrence of an error from the image processing apparatus 62 or receiving no processing result from the image processing apparatus 62 in a prescribed time after requesting it to execute the second service process, the cooperative processing server 50 judges that an error has occurred in the image processing apparatus 62. The cooperative processing server 50 generates new instruction data that is to replace the instruction data being executed.

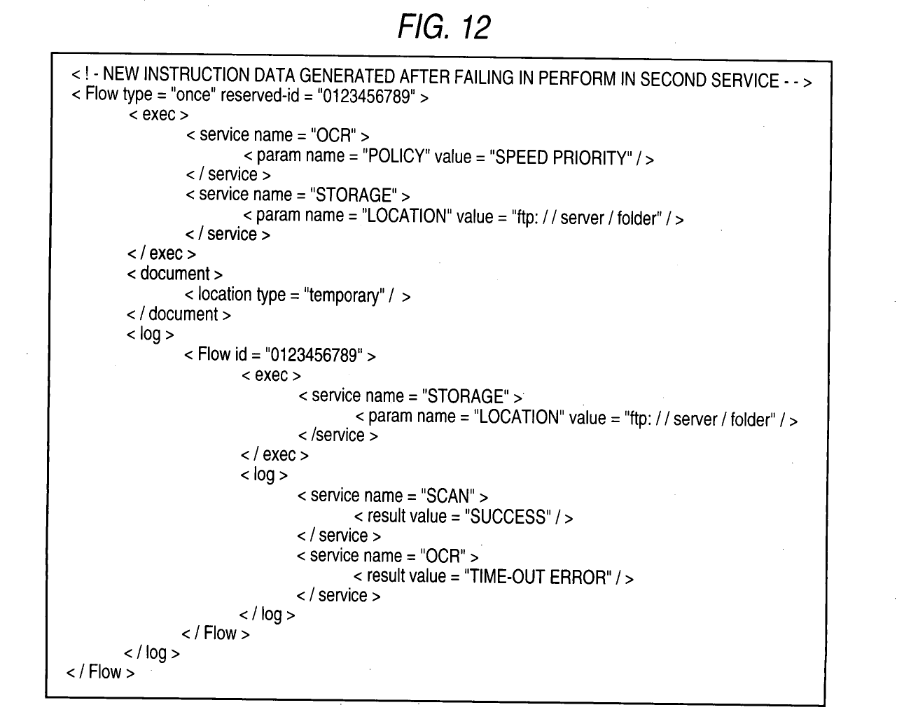

FIG. 12 shows the structure of the main part of new instruction data that is generated when an error occurs during execution of the second service process.

As shown in FIG. 12, the instruction data includes <type=“once”> and <reserved-id=“0123456789”> in the tag of <flow>. <type=“once”> means that this new instruction data can be executed only once. This is to prevent the new instruction data from being executed repeatedly, because it is intended only for re-execution after the occurrence of the error. The term “re-execution” means execution of a service process in which an error has occurred and service processes following it. <Reserved-id=“0123456789”> means that the same ID as in the original instruction data has been assigned.

The new instruction data also has, as elements of <flow>, <document> in addition to <exec> and <log>. <Document> indicates a location where document data that have been processed before the occurrence of the error is stored.

For example, <location type=“temporary”> exists in the <document> portion shown in FIG. 12, which means that the cooperative processing server 50 stored the document data in its own work area. The cooperative processing server 50 may write, as <location type>, <attachment> indicating that document data are attached to instruction data or a prescribed URL (e.g., “ftp://FileServer/Folder/” indicating a folder of the instruction data management server 40).

On the other hand, the second service process (OCR) and the third service process (storage) which are subjects of the re-execution are described in the <exec> portion. The ID of the original instruction data (<id=“0123456789”> ) is written in the <log> portion. The <log> portion shows that a time-out error occurred in the second service process “OCR” and the third service process “storage” has not be executed yet.

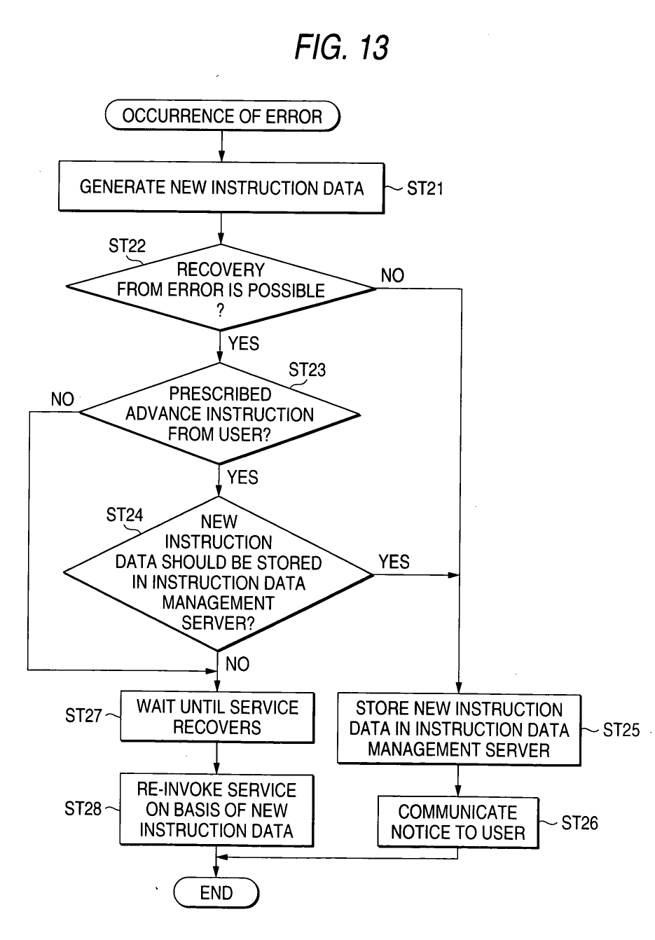

FIG. 13 is a flowchart showing a process that is executed by the cooperative processing server 50 when an error has occurred. If an error occurs during execution of a cooperative process (e.g., an error in the service process of the image processing apparatus 62 at step ST14 in FIG. 8), the cooperative processing server 50 executes step ST21 and the following steps.

At step ST21, as shown in FIG. 12, the cooperative processing server 50 generates new instruction data in which the service “scan” that has already been performed is removed from the <exec> portion of the current instruction data and the current instruction data (i.e., the instruction data that was being executed when the error occurred) is attached as <log>. The process then goes to step ST22.

At step ST22, the cooperative processing server 50 judges whether recovery from the error in the image processing apparatus 62 is possible. If recovery from the error is possible, the process goes to step ST23. On the other hand, if recovery from the error is not possible, the process goes to step ST25.

At step ST23, the cooperative processing server 50 judges, on the basis of the new instruction data, whether a prescribed advance instruction from a user exists. If a prescribed advance instruction from a user exists, the process goes to step ST24. If not, the process goes to step ST27.

At step ST24, the cooperative processing server 50 judges whether to store the new instruction data in the instruction data management server 40. If the instruction data should be stored in the instruction data management server 40, the process goes to step ST25. If not, the process goes to step ST27.

The cooperative processing server 50 stores the new instruction data in the instruction data management server 40 at step ST25 and communicates a notice to that effect to the client terminal 10 at step ST26. The process is then finished.

On the other hand, at step ST27, the cooperative processing server 50 waits until the service (in this example, of the image processing apparatus 62) where the error occurred recovers. If the service has recovered, the process goes to step ST28. At step ST28, the cooperative processing server 50 re-invokes, on the basis of the new instruction data, the service where the error occurred and re-executes that service and the services following it. The process is then finished.

As described above, if an error has occurred in one of prescribed services, as shown in FIG. 12 the cooperative processing server 50 generates new instruction data and hence can smoothly re-execute the service where the error occurred and the services following it without terminating the cooperative process halfway.

That is, when receiving a re-execution instruction, the cooperative processing server 50 reads a document that was being processed at the occurrence of an error by referring to the <document> portion of new instruction data from a storage location and can thereby re-execute a service where the error occurred and services following it by referring to the <exec> portion of the new instruction data.

Although this embodiment has been described by using the specific examples of the first to third service processes, it goes without saying that the invention is not limited to the case involving those examples.

### Embodiment 2

Next, a second embodiment of the invention will be described. In the second embodiment, apparatus, components, etc. having the same ones in the first embodiment are given the same reference numerals and will not be described in detail. In the first embodiment, when an error has occurred, the cooperative processing server 50 starts re-execution from the state of the instant when the error occurred. In contrast, in the second embodiment, the following process can also be executed.

[Substitution Process]

By using instruction data to be described later, the cooperative processing server 50 according to this embodiment can execute a process of replacing a service where an error occurred.

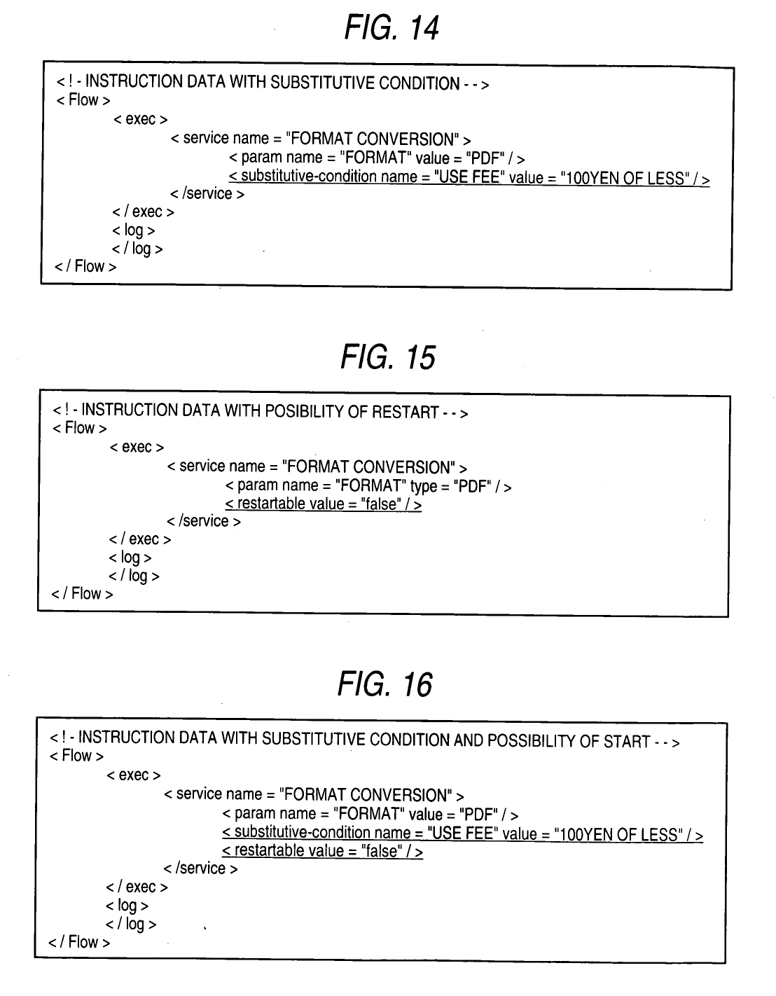

FIG. 14 shows the structure of the main part of instruction data with a substitutive condition. That is, this instruction data has a condition on the basis of which to judge whether a service can be replaced at the occurrence of an error. In the instruction data, “format conversion” is written as a name of <service> to be performed. <Service> has <substitutive-condition> in addition to <param>. <Substitutive-condition> indicates a condition that a substitution service for replacing a service where an error occurred should satisfy. For example, in FIG. 14, <substitutive-condition> has a name “use fee” and a setting value “100 yen or less.”

When an error has occurred in the service process of “format conversion,” the cooperative processing server 50 refers to <substitutive-condition> in the instruction data and searches for a substitution service (i.e., service processing apparatus) that performs format conversion at 100 yen or less (use fee). If finding such a service processing apparatus, the cooperative processing server 50 causes that service processing apparatus to perform format conversion. If failing in finding such a service processing apparatus, the cooperative processing server 50 generates new instruction data as in the case of the first embodiment.

Naturally, instead of the cooperative processing server 50, the service search server 20 may search for a substitute service processing apparatus, on the basis of an instruction from the cooperative processing server 50.

[Restart Process]

By using instruction data to be described later, the cooperative processing server 50 according to this embodiment can execute a restart process. The term “restart” means executing service processes from the start of a job flow after occurrence of an error.

FIG. 15 shows the structure of the main part of instruction data with a possibility of restart. That is, this instruction data shows whether restart can be effected from the start when an error has occurred. In the instruction data, “format conversion” is written as a name of <service> to be performed. <Service> has <restartable> in addition to <param>. <Restartable> indicates whether restart can be effected from the start when an error has occurred. In FIG. 15, <restartable> has a setting value “false,” which means restart cannot be effected.

If an error has occurred in the service process “format conversion,” the cooperative processing server 50 refers to <restartable> in instruction data. If <restartable> has a setting value “false” as in the case of FIG. 15, the cooperative processing server 50 generates new instruction data for a service where the error occurred and services following it as in the case of the first embodiment. If <restartable> has a setting value “true,” the cooperative processing server 50 may either effect restarting from the start or generate new instruction data for a service where the error occurred and services following it as in the case of the first embodiment.

[Instruction Data with Substitutive Condition and Possibility of Restart]

By using instruction data to be described later, the cooperative processing server 50 according to this embodiment can execute various processes with switching made among them.

FIG. 16 shows the structure of the main part of instruction data with a substitutive condition and a possibility of restart. This instruction data has the functions of both instruction data shown in FIGS. 14 and 15. In the instruction data, <service> has <substitutive-condition> and <restartable> in addition to <param>. That is, this instruction data shows that when an error occurs during the format conversion, a substitute service whose use fee is 100 yen or less can be used and restart cannot be effected.

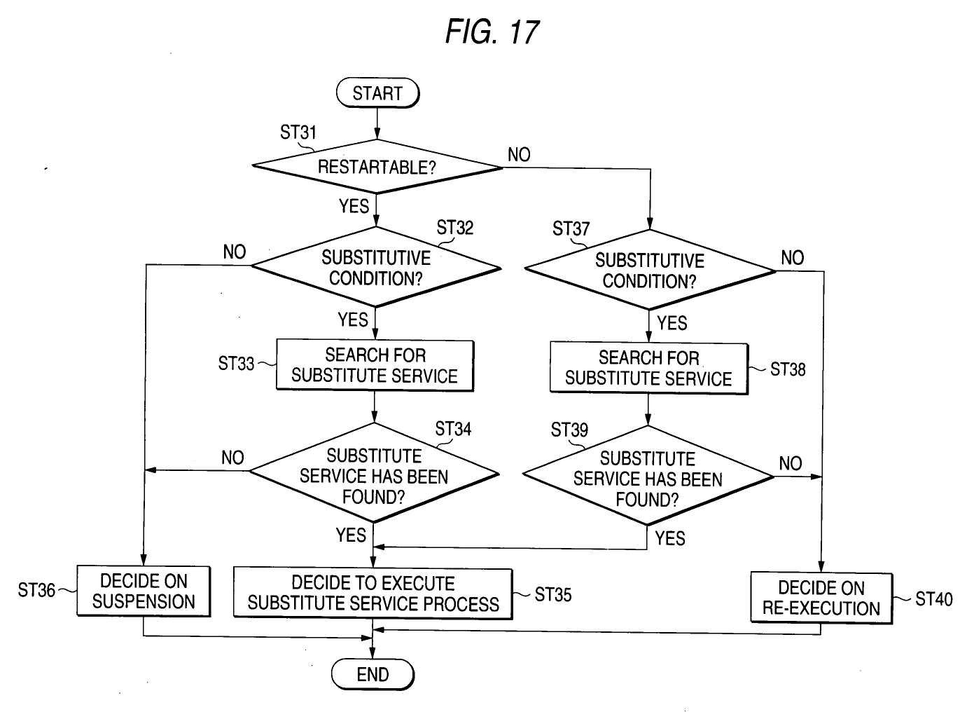

FIG. 17 is a flowchart showing a cooperative process that is executed by the cooperative processing server 50. If an error occurs while a cooperative process is being executed according to the instruction data of FIG. 16, the cooperative processing server 50 executes step ST31 and the steps following it.

At step ST31, the cooperative processing server 50 judges, on the basis of <restartable> in the instruction data, whether restart is possible. If <restartable> has a setting value “true,” the cooperative processing server 50 judges that restart is possible and moves to step ST32. If <restartable> has a setting value “false,” the cooperative processing server 50 judges that restart is not possible and moves to step ST37.

At step ST32, the cooperative processing server 50 judges whether the instruction data includes <substitutive condition>. If the instruction data includes <substitutive condition>, the process goes to step ST33. If not, the process goes to step ST36.

At step ST33, the cooperative processing server 50 searches the network for a substitute service on the basis of the name “use fee” and the setting value “100 yen or less” of <substitutive condition> in the instruction data. That is, the cooperative processing server 50 searches for a service for performing format conversion at 100 yen or less (use fee) and moves to step ST34. Instead of the cooperative processing server 50, the service search server 20 may search for a substitute service processing apparatus, on the basis of an instruction from the cooperative processing server 50.

At step ST34, the cooperative processing server 50 judges whether a substitute service has been found. If a substitute service has been found, the process goes to step ST35. If not, the process goes to step ST36.

At step ST35, the cooperative processing server 50 decides to execute a substitute service process and sends individual instruction information to the substitute service processing apparatus for performing format conversion. In this manner, the cooperative processing server 50 can continue the format conversion process without suspension.

At step ST36 to which a transition has been made from step ST32 or ST34, the cooperative processing server 50 decides to suspend the format conversion process. That is, the cooperative processing server 50 suspends the cooperative process if the instruction data does not include <substitutive condition> or restart from the start is possible in the case where no substitute service has been found.

On the other hand, at step ST37, the cooperative processing server 50 judges whether the instruction data includes <substitutive condition>. If the instruction data includes <substitutive condition>, the process goes to step ST38. If not, the process goes to step ST40.

At step ST38, the cooperative processing server 50 searches for a substitute service for performing format conversion at 100 yen or less (use fee) on the basis of <substitutive condition> in the instruction data. The process then goes to step ST39. Instead of the cooperative processing server 50, the service search server 20 may search for a substitute service processing apparatus.

At step ST39, the cooperative processing server 50 judges whether a substitute service has been found. If a substitute service has been found, the process goes to step ST35. If not, the process goes to step ST40.

At step ST40, the cooperative processing server 50 decides on re-execution. That is, the cooperative processing server 50 generates new instruction data as shown in FIG. 12 and re-executes the service where the error occurred and services following it on the basis of the new instruction data, as in the case of the first embodiment. The cooperative processing server 50 may store the new instruction data in the instruction data management server 40. This allows the cooperative processing server 50 to re-execute the service where the error occurred and the services following it without wasting execution-completed services.

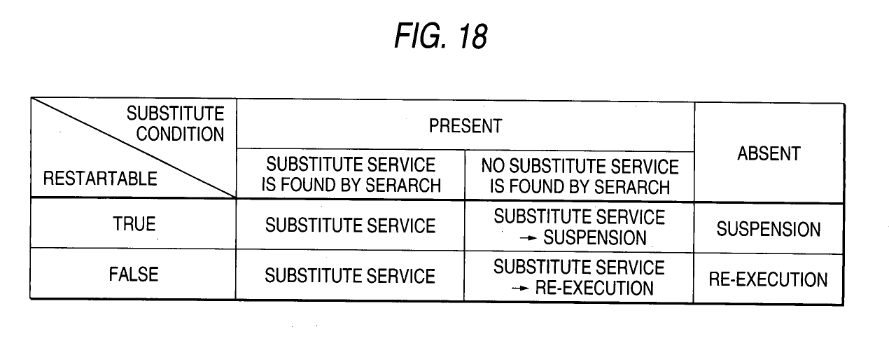

FIG. 18 is a table showing how the cooperative processing server 50 selects a process for a combination of <substitutive condition> and <restartable> in the instruction data. In the table, “substitute service→suspension” means that execution of a substitute service was intended but a cooperative process is suspended because no substitute service has been found by a search. “Substitute service→re-execution” means that execution of a substitute service was intended but re-execution is effected because no substitute service has been found by a search.

As described above, if an error occurs during execution of a service process, the cooperative processing server 50 according to the second embodiment can suspend the following service processes, cause a substitute service processing apparatus that has been found by a search to execute a substitute service process, or generate new instruction data and effect re-execution as in the case of the first embodiment.

In particular, the cooperative processing server 50 can execute a process that is suitable for the needs of a user even at the occurrence of an error by selecting suspension of a cooperative process, execution of a substitute service process, or re-execution by referring to <substitutive condition> and <restartable> in instruction data when an error has occurred during execution of a service process.

The invention is not limited to the first and second embodiments, and can also be applied to apparatus that are modified in design within the scope of the claims.

For example, it goes without saying that the process to be executed by the cooperative processing server 50 is not limited to the one shown in the flowchart of FIG. 17 as long as a selection can be made in the manner shown in FIG. 18 on the basis of instruction data.

In the cooperative processing apparatus and the cooperative processing method according to the invention, even if a service processing apparatus whose turn in the order of services of a cooperative process has come is rendered unable to perform its service, second cooperation instruction information is generated that orders cooperative execution of the service that became unexecutable and services following it. In a re-execution process, the cooperative execution of the service that became unexecutable and the following services can be executed reliably by using the second cooperation instruction information.

The entire disclosure of Japanese Patent Application No. 2003-081613 filed on Mar. 24, 2003 including specification, claims, drawings and abstract is incorporated herein by reference in its entirety.

What is claimed is:

1. A cooperative processing apparatus comprising:
a service execution requesting unit for requesting, on the basis of first cooperation instruction information that instructs cooperative execution, via a network, of respective processes of plural services of a cooperative process on document data, a service processing apparatus for executing a service; and
a cooperation instruction information generating unit for generating, if a service processing apparatus which is requested for executing a service by the service execution requesting unit has become incapable of executing the service, second cooperation instruction information that instructs cooperative execution of the service which the service processing apparatus has become incapable of executing and services following it.

2. The cooperative processing apparatus according to claim 1, wherein the cooperation instruction information generating unit generates the second cooperation instruction information when the service processing apparatus has become incapable of executing the service whose turn in order of the plural services has come.

3. The cooperative processing apparatus according to claim 1, wherein the cooperation instruction information generating unit generates second cooperation instruction information by performing at least one of an operation of incorporating the same identification information as of the first cooperation instruction information in the second cooperation instruction information and an operation of deleting execution-completed services and writing, in the second cooperation instruction information, a statement to the effect that remaining services should be executed in a cooperative manner via the network.

4. The cooperative processing apparatus according to claim 1, wherein the cooperation instruction information generating unit generates second cooperation instruction information including storage destination information of document data that has been processed before the service processing apparatus became incapable of executing the service.

5. The cooperative processing apparatus according to claim 1, wherein the cooperation instruction information generating unit generates second cooperation instruction information including log information indicating execution-completed services or second cooperation instruction information to which the first cooperation instruction information is attached.

6. The cooperative processing apparatus according to claim 1, wherein when instructed to effect re-execution, the service execution requesting unit requests, on the basis of the second cooperation instruction information, a service processing apparatus for executing a service whose turn has come to execute the service.

7. The cooperative processing apparatus according to claim 1, further comprising:
a cooperative process suspending unit for suspending the cooperative process if a service processing apparatus has become incapable of executing the service whose turn in order of the plural services has come;
a search unit for searching for a substitute service processing apparatus when a service processing apparatus has become incapable of executing the service whose turn in order of the plural services has come; and
a control unit for switching-controlling the cooperation instruction information generating unit, the cooperative process suspending unit, and the search unit on the basis of the first cooperation instruction information.

8. A cooperative processing method comprising:
requesting, on the basis of first cooperation instruction information that instructs cooperative execution, via a network, of respective processes of plural services of a cooperative process on document data, a service processing apparatus for executing a service; and
generating, if a service processing apparatus which is requested for executing a service by the service execution requesting unit has become incapable of executing the service, second cooperation instruction information that instructs cooperative execution of the service that the service processing apparatus has become incapable of executing and services following it.

9. The cooperative processing method according to claim 8, wherein the second cooperation instruction information is generated when the service processing apparatus has become incapable of executing the service whose turn in order of the plural services has come.

10. The cooperative processing method according to claim 8, wherein second cooperation instruction information is generated by performing at least one of an operation of incorporating the same identification information as of the first cooperation instruction information in the second cooperation instruction information and an operation of deleting execution-completed services and writing, in the second cooperation instruction information, a statement to the effect that remaining services should be executed in a cooperative manner via the network.

11. The cooperative processing method according to claim 8, wherein second cooperation instruction information including storage destination information of document data is generated, the document data having been processed before the service processing apparatus became incapable of executing the service.

12. The cooperative processing method according to claim 8, wherein second cooperation instruction information including log information indicating execution-completed services or second cooperation instruction information to which the first cooperation instruction information is attached is generated.

13. The cooperative processing method according to claim 8, wherein when instructed to effect re-execution, on the basis of the second cooperation instruction information, a service processing apparatus is requested for executing a service whose turn has come to execute the service.

14. The cooperative processing method according to claim 8, further comprising:
suspending the cooperative process if a service processing apparatus has become incapable of executing the service whose turn in order of the plural services has come;
searching for a substitute service processing apparatus when a service processing apparatus has become incapable of executing the service whose turn in order of the plural services has come; and
switching-controlling the cooperation instruction information generation, the cooperative process suspension, and the search on the basis of the first cooperation instruction information.
